(19) United States
(12) Patent Application Publication
(10) Pub. No.: US 2008/0185255 A1
(43) Pub. Date: Aug. 7, 2008

(54) Plate clutch for motor vehicles, especially motorcycles

(75) Inventor: Johannes Mintzlaff, Hoehenkirchen/Siegertsbrunn (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/102,441

(22) Filed: Apr. 14, 2008

Related U.S. Application Data
(63) Continuation of application No. PCT/EP2006/011746, filed on Dec. 7, 2006.

(30) Foreign Application Priority Data
Jan. 26, 2006 (DE) 10 2006 003 665.4

(51) Int. Cl. F16D 13/50

(52) U.S. Cl. 192/70.27

(57) ABSTRACT

A plate clutch for motor vehicles especially motorcycles, which are arranged to ensure its pressure plate is centered, to ensure that a release force is concentrically applied, and to permit use of a spring type which reduces clutch release force and thereby improves operator comfort. The plate clutch includes a primary gear driven by an engine and rotatably mounted on a clutch shaft, a clutch cage connected to the primary gear and corresponding driver connected to the clutch shaft, a pressure plate splined to the driver, a pressure pad rigidly connected to the pressure plate, a belleville spring supported on the driver and on the pressure pad, annular clutch plates, stacked between the pressure plate and the driver, a throwout bearing which transfers an axial release force to the pressure plate, and a pressure mushroom inserted into the internal ring of the throwout bearing and lying against it with an annular flange. The pressure mushroom (20) is provided with an extending into an axial coaxial hole of the clutch shaft (10).

### CROSS-REFERENCE TO RELATED APPLICATIONS

This application is a continuation of PCT International Application No. PCT/EP2006/011746, filed on Dec. 7, 2006, which claims priority under 35 U.S.C. § 119 to German Patent Application No. 10 2006 003 665.4, filed Jan. 26, 2006, the entire disclosures of which are expressly incorporated by reference herein.

### BACKGROUND AND SUMMARY OF THE INVENTION

The invention concerns a plate clutch for motor vehicles, especially motorcycles, comprising a primary gear coupled to the flywheel of an internal combustion engine, which is mounted to rotate on a clutch shaft, a clutch cage rigidly connected to the primary gear, a driver arranged concentric to the clutch shaft and rigidly connected to it, a pressure plate axially movable with the driver, but splined to it, a pressure pad rigidly connected to the pressure plate, a belleville spring, which is supported on an outer peripheral area on the driver and on an inner peripheral area on the pressure pad, a stack of annular clutch plates, which are connected alternating on the inner or outer periphery with the driver and splined to the cage, but axially movable, the plates being clamped between the pressure plate and the driver, a throwout bearing arranged coaxial to the clutch shaft, via which an axial throw-out force can be transferred to the pressure plate, and a pressure mushroom inserted into the internal ring of the throwout bearing and lying against it with an annular flange.

Ordinary plate clutches of this type often have a belleville spring with a plateau-like spring characteristic. The operating point and release point of the clutch then lie in a linear horizontal area of the spring characteristic. This means that the same spring force prevails at the operating point and the release point of the clutch. In other words, the force required to open the clutch is identical to the spring force prevailing in the closed state of the clutch.

Because of unavoidable tolerances of different components of such a plate clutch, the point of application of the slave cylinder for operation of the clutch never lies precisely on the axis of rotation of the clutch. This means that the [master] slave cylinder presses against the pressure plate eccentrically via the pressure mushroom and throwout bearing. In an ordinary belleville spring with a linear characteristic, this only leads to a slight oblique position of the pressure plate, since the progressive spring reacts with a higher counterforce. This is also true, in principle, for a belleville spring with a plateau-like spring characteristic.

In motorcycles with high power, the manual force required to disengage the clutch, which the motorcyclist must exert on the clutch lever, can assume significant values. When a belleville spring with a plateau-like spring characteristic is used, the manual force to be exerted on the clutch lever is constant over the entire operating path. To reduce the manual force required for disengagement of the clutch and the work to be dealt with in so doing, the use of a belleville spring with a degressive characteristic from the operating point in the operating direction is proposed. Because of this falling characteristic, the work required to open the clutch can be cost-effectively reduced, because the manual force diminishes over the path of the clutch lever. This means a significant gain in comfort for the motorcyclist. Because of eccentric loading of the pressure plate for the reasons just mentioned, however, during disengagement of the clutch, the use of a clutch spring with a degressive characteristic in an ordinary plate clutch is not possible. In a degressive spring in the operating range, reinforcement of the oblique position of the pressure plate occurs, since the more strongly pressed side of the spring reacts with a lower counterforce. The strong oblique position of the pressure plate causes significant deterioration in separation behavior of the clutch. This is made noticeable to the motorcyclist by a loud engagement noise of first gear, loud switching noises and poor idle stability. In addition, this type of poorly separating clutch has a tendency toward severe shudder with tumbling clutch plates as a result of the obliquely positioned pressure plate.

Because of unavoidable component tolerances, there is also a certain radial play that permits oblique positioning of the pressure plate.

The underlying task of the invention is to improve the plate clutch according to the invention, so that during operation, an oblique position and eccentric force introduction is prevented.

This task is solved according to the invention in that the pressure mushroom is provided with an extension, which is guided to coaxial movement in a hole of the clutch shaft. This expedient guarantees that the operating force is introduced concentrically to the clutch. In addition, an oblique position, because of additional component tolerances and radial play, is suppressed. The plate clutch according to the invention is therefore suited for use of a belleville spring with a falling characteristic from the operating point in the operating direction. This type of belleville spring offers a cost-effective possibility for reducing the manual force for clutch operation and therefore a significant gain in comfort for the motorcyclist. Centering of the pressure plate is achieved with the pressure mushroom guided in the clutch shaft in an effective and inexpensive manner. The expedient according to the invention can be implemented in the existing space and entails only a slightly additional weight.

Other objects, advantages and novel features of the present invention will become apparent from the following detailed description of the invention when considered in conjunction with the accompanying drawings.

### BRIEF DESCRIPTION OF THE DRAWINGS

FIG. 1 is an illustration of a plate clutch in longitudinal section in accordance with an embodiment of the present invention.

### DETAILED DESCRIPTION OF THE DRAWINGS

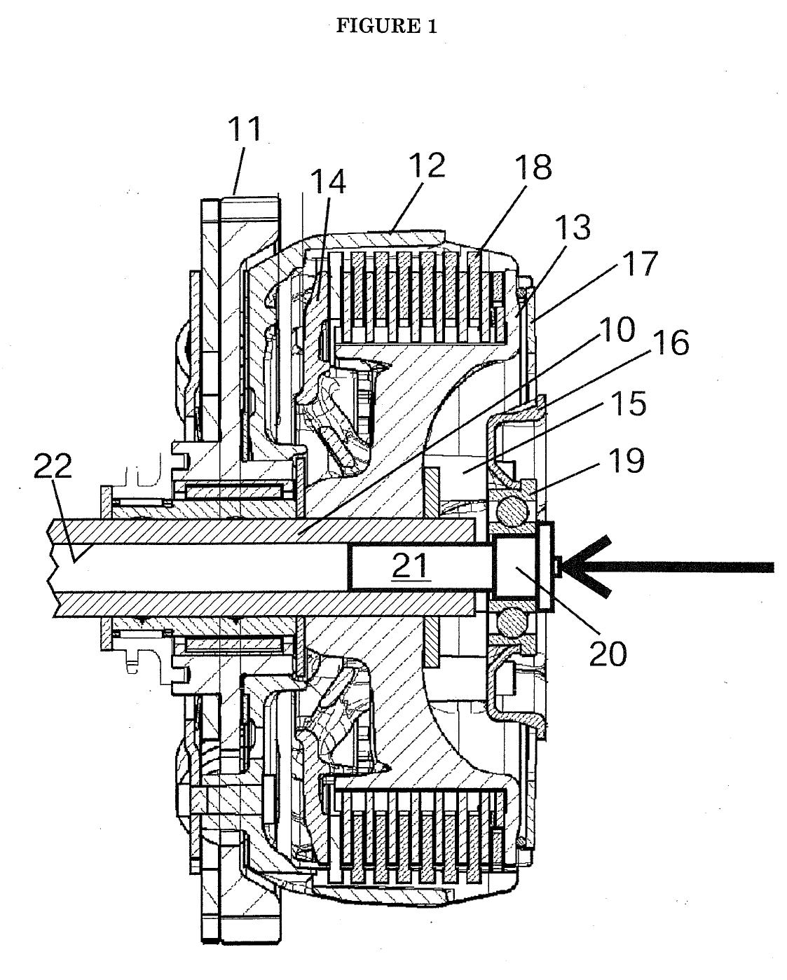

The plate clutch depicted in the FIG. 1 drawing is intended, in particular, for use in a motorcycle. A gear, the so-called primary gear 11, is mounted to rotate with a roller bearing on a clutch shaft 10. The primary gear 11 is driven by the (not shown) crankshaft of an internal combustion engine. A housing, the so-called cage 12, is splined to the primary gear 11. A driver 13 is splined to the clutch shaft 10 and fixed axially. A pressure plate 14 is splined to the driver 13, but axially movable. The pressure plate 14 has several domes 15 that extend axially between the spoke to the driver 13. A pressure pad 16 is rigidly connected to pressure plate 14. More precisely stated, the pressure pad 16 is screwed to the domes 15. An annular belleville spring 17 is supported on the outer peripheral area on driver 13 and on the inner peripheral area on pressure pad 16. The stack of annular clutch plates 18 is clamped between the driver 13 and pressure plate 14. Driving and driven plates 18 are arranged in alternation one behind the other. The driving plates are geared on their outer periphery. Their teeth engage in corresponding grooves of the clutch cage 12. The driven plates engage with teeth in corresponding grooves of driver 13, which is splined to clutch shaft 10 and axially fixed. The plates 18 are axially movable in the corresponding grooves of cage 12 or driver 13. The plates 18 run in an oil bath, for which reason a wet clutch is also spoken of. A throwout bearing 19 is inserted into an opening of the pressure pad 16 concentric to the clutch shaft 10, which is supported with an annular flange on the pressure pad 16. A cylindrical pressure mushroom 20 is inserted into the internal ring of the throwout bearing 19, which is supported with an annular flange on the internal ring.

To interrupt force flow from the internal combustion engine (not shown) to a manual gear box (also not shown), i.e., for opening of the clutch, a force, indicated by an arrow, is exerted in the axial direction on pressure mushroom 20. This force is transferred via throwout bearing 19 and pressure pad 16 to domes 15, so that the pressure plate 14 is moved leftward. This means that the force of the belleville spring 17 no longer acts on plates 18. They loosen from each other on this account and force transfer is interrupted. If the force exerted on pressure mushroom 20 is released, the pressure pad 16 and the pressure plate 14 connected to it are moved rightward under the bias of belleville spring 17, so that the plates 18 are tightened between pressure plate 14 and driver 13 and a torque can therefore be transferred from the primary gear 11 to the clutch shaft 10.

A plate clutch with the design just described is generally known, so that further explanation is unnecessary.

The design and positioning of the pressure mushroom 20 is new. This has a concentric cylindrical extension 21, which is guided free of play in a concentric hole 22 of the clutch shaft 10 to axial movement. Because of this guiding of the pressure mushroom 20 in the clutch shaft 10, three things are achieved. In the first place, the pressure plate 14 is centered and, in the second place, during opening of the clutch, a concentric introduction of the release force is guaranteed. In the third place, direct restriction of the tilting play is produced. An oblique position of the pressure plate 14 is therefore reliably avoided. This circumstance permits the use of a belleville spring 17 with a characteristic falling from the operating point in the operating direction. The advantage of such a belleville spring consists of reducing the manual force for clutch operation and therefore a gain in comfort for the motorcyclist. Owing to the fact that an oblique position of the pressure plate 14 and therefore the plates 18 is prevented, problems, like loud shifting noise, especially on entering first gear, poor detectability of idle or shudder of the clutch, are avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

10 Clutch shaft
11 Primary gear
12 Cage
13 Driver
14 Pressure plate
15 Dome
16 Pressure pad
17 Belleville spring
18 Plates
19 Throwout bearing
20 Pressure mushroom
21 Extension
22 Hole

What is claimed is:

1. A plate clutch for motor vehicles, comprising:
a primary gear configured to be coupled to a flywheel of an internal combustion engine;
a clutch shaft, upon which the primary gear is rotatably mounted;
a clutch cage rigidly connected to the primary gear;
a driver arranged concentrically on, and rigidly connected to, the clutch shaft;
a pressure plate, the pressure plate being coupled to the driver so as to permit axial movement of the pressure plate relative to the driver;
a pressure pad rigidly connected to the pressure plate;
a Belleville spring, the Belleville spring being supported on the driver at an outer peripheral area of the Belleville spring and on the pressure pad at an inner peripheral area of the Belleville spring;
a stack of annular clutch plates, alternate plates of said stack being coupled with the cage or the driver in a manner which permits axial movement of the plates in response to application and release of pressure applied between the pressure plate and the driver;
a throwout bearing arranged coaxially to the clutch shaft to apply an axial release force via the pressure pad to the pressure plate; and
a pressure mushroom with an annular flange and extension which receives a clutch actuation force, wherein the annular flange rests against an internal ring of the throwout bearing, and the extension is guided in an axial hole of the clutch shaft so as to permit coaxial axial movement of the extension within the axial hole upon application of the clutch actuation force on the pressure mushroom.
